(19) United States
(12) Patent Application Publication
(10) Pub. No.: US 2008/0016119 A1
(43) Pub. Date: Jan. 17, 2008

(54) Quality Assurance System and Method

(76) Inventors: Parit K. Sharma, Cambridge (CA); Michael A. Denomme, London (CA)

Correspondence Address: FISH & RICHARDSON P.C., P.O. BOX 1022, MINNEAPOLIS, MN, 55440-1022, US

(21) Appl. No.: 11/778,521

(22) Filed: Jul. 16, 2007

Related U.S. Application Data
(60) Provisional application No. 60/830,907, filed on Jul. 14, 2006.

(51) Int. Cl. G06F 17/00

(52) U.S. Cl. 707/104.1

(57) ABSTRACT

Systems, processes, and devices may facilitate quality assurance in a manufacturing process. In certain implementations, systems, processes, and devices for quality assurance may include the ability to receive inspection data regarding an item being manufactured, the item having a number of components, and insert the data into a data organization. The data organization may include a first data structure for capturing identification data regarding the item and the inspections for the item, a second data structure for capturing data regarding defects in the item's components, and a third data structure for capturing data regarding the item's components. A fourth data structure may be linked to the first, second, and third data structures for capturing data regarding the item, the inspections for the item, the defects for the item's components, and the components containing the defects. The data organization may be used to generate responses to queries.

### RELATED APPLICATIONS

This application claims priority to U.S. Provisional Application No. 60/830,907, entitled “Quality Assurance System and Method” and filed on Jul. 14, 2006, the entire contents of which is incorporated by reference herein.

### BACKGROUND

Industries around the world are constantly striving for cost-effective techniques to improve customer satisfaction and deliver higher levels of quality. As part of this, manufacturers are forced to identify and eliminate the sources of product and process errors in their manufacturing operations. Unfortunately, manufacturers of complicated products may have many different points for quality assessment and control during their build operations. During a vehicle assembly process, for example, the vehicles enter and leave a number of different stations at which different components (e.g., airbags, seats, windows, moldings, etc.) of the vehicle are attached and processed. Moreover, the quality assessments and controls at each station may be disparate from each other.

### SUMMARY

Systems, processes, and devices may facilitate capturing and evaluating data for quality assurance in a manufacturing process. In one general aspect, a system for quality assurance may include a number of inspection stations and a data management system. The inspection stations may be operable to receive data regarding an item that is being manufactured, which may have one or more components. The data management system may be coupled to the inspection stations and include a data manager operable to generate responses to queries by using a data organization. The data organization may include a first data structure for capturing identification data regarding the item being manufactured and the inspections for the item, a second data structure for capturing data regarding defects in the components of the item, a third data structure for capturing data regarding the components of the item, and a fourth data structure linked to the first, second, and third data structures for capturing data regarding the item, the inspections for the item, the defects for the components of the item, and the components containing the defects. The item being manufactured may, for example, be an automobile, and the data organization may be a relational database that has tables as data structures.

The first data structure may be linked to a fifth data structure and a sixth data structure, the fifth data structure for capturing data regarding the item being manufactured and the sixth data structure for capturing data regarding inspection stations for the manufacturing process. The sixth data structure may be linked to a seventh data structure for capturing data regarding an area of the manufacturing process. The data management system may associate a defect in an item with an inspection station.

The second data structure may be linked to an eighth data structure for capturing data regarding potential defects for the components of the item and a ninth data structure for capturing data regarding the inspection stations and components inspected thereby. The data management system may associate a defect with a component and an inspection station. The ninth data structure may be linked to a tenth data structure and an eleventh data structure, the tenth data structure for capturing data regarding inspection stations for the manufacturing process and the eleventh data structure for capturing data regarding components of the item. The ninth data structure may specify associations between inspection stations and the components of the item. For example, a plurality of inspection stations may be associated with one component. The second data structure may specify associations between potential defects and components of an item.

The second data structure may also be linked to a twelfth data structure for capturing data regarding the location of a defect. The data management system may associate a defect with a location on an item. The second data structure may additionally be linked to a thirteenth data structure for capturing standardized defect codes.

The third data structure may also capture data regarding departments of the manufacturing process associated with components of the item. The third data structure may be linked to a fourteenth data structure and fifteenth structure, the fourteenth data structure for capturing data regarding a department in the manufacturing process and the fifteenth data structure for capturing data regarding sub-components of components. The data management system may associate a defect with a department in the manufacturing process.

In another general aspect, a process for quality assurance in a manufacturing process may include receiving inspection data regarding an item that is being manufactured, which may include one or more components, inserting the data into a data organization, and generating responses to queries by using the data organization. The data organization may include a first data structure for capturing identification data regarding the item being manufactured and the inspections for the item, a second data structure for capturing data regarding defects in the components of the item, a third data structure for capturing data regarding the components of the item, and a fourth data structure linked to the first, second, and third data structures for capturing data regarding the item, the inspections for the item, the defects for the components of the item, and the components containing the defects.

The first data structure may be linked to a fifth data structure and a sixth data structure, the fifth data structure for capturing data regarding the item being manufactured and the sixth data structure for capturing data regarding inspection stations for the manufacturing process. The process may also include associating a defect in an item with an inspection station.

The second data structure may be linked to an seventh data structure for capturing data regarding potential defects for the components of the item and an eighth structure for capturing data regarding the inspection stations and components inspected thereby. The eighth data structure may specify associations between inspection stations and the components of the item. The second data structure may specify associations between potential defects and components of an item.

The second data structure may also be linked to a ninth data structure for capturing data regarding the location of a defect. The process may also call for associating a defect with a component and an inspection station.

The third data structure may also capture data regarding departments of the manufacturing process associated with components of the item. The process may additionally call for associating a defect with a department in the manufacturing process.

In an additional general aspect, a system for quality control in a manufacturing process may include means for receiving inspection data regarding an item that is being manufactured, which may include a plurality of components, means for inserting the data into a data organization, and means for generating responses to queries by using the data organization. The data organization may include a first data structure for capturing identification data regarding the item being manufactured and the inspections for the item, a second data structure for capturing data regarding defects in the components of the item, a third data structure for capturing data regarding the components of the item, and a fourth data structure linked to the first, second, and third data structures for capturing data regarding the item, the inspections for the item, the defects for the components of the item, and the components containing the defects.

In a particular general aspect, a quality control system for a manufacturing process may include a plurality of inspection stations for receiving data regarding an item that is being manufactured, which may include one or more components, and a data management system coupled to the inspection stations, the data management system including a data manager for generating responses to queries by using a data organization. The data organization may include a first data structure for capturing identification data regarding the item being manufactured and the inspections for the item, a second data structure linked to the first data structure, the second data structure for capturing data regarding the item being manufactured, a third data structure linked to the first data structure, the third for capturing data regarding inspection stations for the manufacturing process, and a fourth data structure linked to the third data structure for capturing data regarding an area of the manufacturing process. The data organization may also include a fifth data structure for capturing data regarding defects in the components of the item and specifying associations between potential defects and components of an item, a sixth data structure linked to the fifth data structure for capturing data regarding potential defects for the components of the item, a seventh data structure linked to the fifth data structure for capturing data regarding the location of a defect, an eighth data structure linked to the fifth data structure for capturing data regarding the inspection stations and components inspected thereby and specifying associations between inspection stations and the components of the item, wherein the third data structure is also linked to the eighth data structure, and a ninth data structure linked to the eighth data structure for capturing data regarding components of the item. The data organization may additionally include a tenth data structure for capturing data regarding the components of the item and departments of the manufacturing process associated with components of the item, an eleventh data structure linked to the tenth data structure for capturing data regarding a department in the manufacturing process, and a twelfth data structure linked to the tenth data structure for capturing data regarding sub-components of components, wherein the ninth data structure is linked to the twelfth data structure. The data organization may further include a thirteenth data structure linked to the first, fifth, and tenth data structures for capturing data regarding the item, the inspections for the item, the defects for the components of the item, and the components containing the defect. The data management system, using the data organization, may associate a defect in an item with an inspection station, associate a defect with a location on an item, associate a defect with a component and an inspection station, and associate a defect with a department in the manufacturing process.

Various implementations may include one or more features. For example, data may be assimilated regarding various parts of a manufacturing process. This may provide the ability to readily capture, store, and generate reports regarding defects identified at various inspection stations in the manufacturing process. The defects may be identified by type, location, inspection station, and/or manufactured item, which may provide insight into the cause of defects. Additionally, reports regarding particular defects, particular periods of time, and/or particular components may be generated. As another example, quality issues may be captured and managed across a broad range of quality data through a single point of tracking. Moreover, even though a broad range of quality data may be assimilated, users may access more quality data through improved throughput and faster, more reliable access to quality data containing the content they are seeking. Quality data may therefore be available across the manufacturing process, at multiple stations, so the status of the items being manufactured can be tracked and made available in real-time, which may be useful for improving overall quality issues. The captured data may also be reviewed with a user-friendly front-end that allows a robust selection criteria.

The details of one or more implementations are set forth in the accompanying drawings and the description below. Other features will be apparent from the description and drawings, and from the claims.

### DESCRIPTION OF DRAWINGS

FIG. 1 is a block diagram illustrating one implementation of a system for quality assurance.

FIG. 2 is a relational diagram illustrating one implementation of a data organization for quality assurance.

FIG. 3 is a block diagram illustrating one implementation of a data management system for quality assurance.

FIG. 4 is a flow chart illustrating one implementation of a process for quality assurance.

Like reference symbols in the various drawings indicate like elements.

### DETAILED DESCRIPTION

Quality assurance may be achieved by capturing data regarding and tracking defects in items from various parts of a manufacturing process. In particular implementations, issues related to quality may be captured, tracked, and reported on in real time as well as from a historical summary point of view. Moreover, multiple stations in the manufacturing process may quickly and efficiently retrieve and resolve the quality data that has been captured at previous stations.

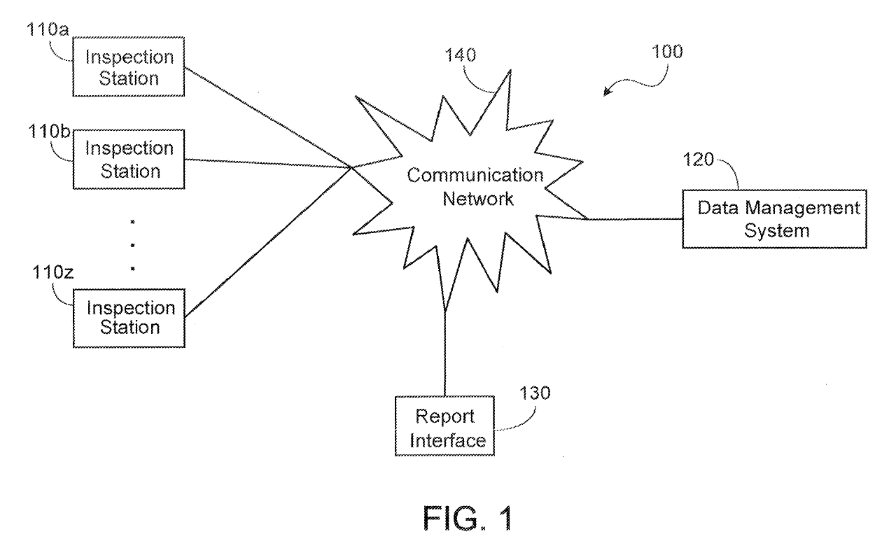

FIG. 1 illustrates one example of a quality control system 100. Quality control system 100 may be useful for providing quality control for plants manufacturing various types of items, such as vehicles (e.g., automobiles), household appliances (e.g., washing machines), electronic devices (e.g., personal computers), or any other appropriate type of item.

In general, quality control system 100 includes inspection stations 110, a data management system 120, and a report interface 130. Inspection stations 110 are adapted to receive data regarding an item that is being manufactured, and data manager 120 is adapted to assimilate the data from inspection stations 110 into a usable form. Report interface 130 is adapted to provide reports, in visual, physical, or other formats, based on the assimilated data. A communication network 140 allows inspection stations 110, data management system 120, and report interface 130 to communicate with each other.

Inspection stations 110 are generally located at various points of the manufacturing process. For example, inspection stations may be located in various departments in a plant and/or at various points along an assembly line. An automobile plant may, for example, include many tens of inspection stations 110. Inspection stations 110 may receive data regarding defects by manual or automated techniques. Manual techniques may, for example, include user entry of data using an appropriate user-input device (e.g., a keyboard, a keypad, a mouse, or a stylus). The input device could, for example, be coupled to a computer (e.g., a PC), a personal digital assistant (PDA), a terminal, or any other appropriate device. Automated techniques may, for example, include automated measuring systems (e.g., laser or volume), automated vision systems (e.g., optical or IR), and/or automated inventory systems (e.g., bar code or RFID). Inspection stations 110 may therefore include any appropriate device for receiving data regarding an item that is being manufactured.

Data management system 120 receives the data from inspection stations 110 and assimilates it into a useful format. The data may be sent by the inspection stations 110 or retrieved by data management system 120. Data management system 120 may assimilate the data by placing it into an appropriate data organization, such as a relational database. Using the data organization, data management system 120 may compile reports regarding defects noted in the manufacturing process. For example, data management system 120 may compile a list of defects for items over a certain time period (e.g., a shift, a day, or a production run), a list of the defects associated with each item, a compilation of defects across items, or otherwise. Data management system 120 may also support acquiring detailed data regarding defects. For example, the data management system may support understanding which types of items the defects are occurring on (e.g., red automobiles), when the defects are occurring (e.g., during a particular shift), or where the defects are occurring (e.g., in a particular department). This data may be useful for tracking down the root cause of problems (e.g., improperly trained employees, improperly functioning machinery, improper supplies, etc.). In particular implementations, data management system 120 may be a server and enter into client-server relationships with inspection stations 110.

Report interface 130 is responsible for providing reports to users. The reports may be provided in a visual format (e.g., on a monitor), a hard-copy format (e.g., printed on paper), or otherwise. Report interface 130 may therefore be a terminal, a monitor connected to a computer, a printer, or any other appropriate device for presenting information to a user. In particular implementations, report interface 130 may be a part of data management system 120.

Communication network 140 may be any appropriate collection of communication devices and/or links for allowing inspection stations 110, data management system 120, and report interface 130 to communicate with each other. For example, communication network 140 may include bridges, routers, repeaters, hubs, switches, transceivers, and/or any other appropriate devices for sending and/or receiving information. Communication network 140 may include wireline links (e.g., coax, CAT 5, etc.), wireless links (e.g., RF or IR), optical links, and/or any other appropriate type of channel for conveying information. In particular implementations, communication network 140 may include a local area network (e.g., Ethernet). In other implementations, communication network 140 may include another type of local area network (e.g., Token Ring) and/or a wide area network (e.g., a corporate intranet).

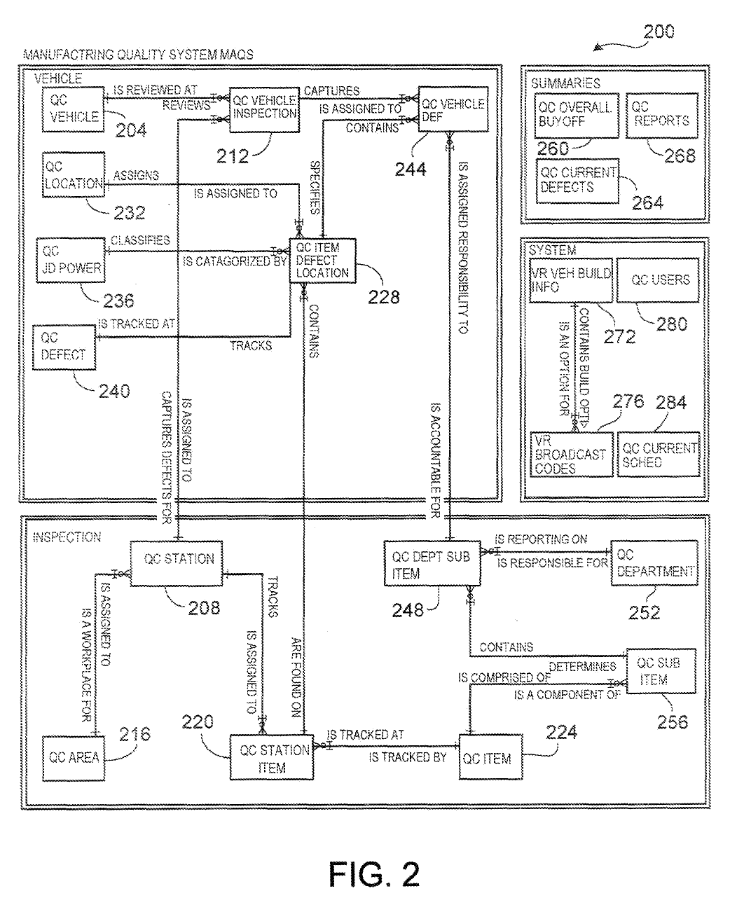

FIG. 2 illustrates one implementation of a data organization 200 for quality assurance. In this implementation, quality assurance data for a vehicle assembly process is captured in a relational database, which could reside on data management system 120. For example, data regarding defects in parts (e.g., a scratched door), as well as the location of the defect, or missing parts may be readily assimilated for report generation and analysis.

Data organization 200 includes several tables, which are types of data structures, and their interrelationships. Table 204 includes data regarding the items being manufactured, in this case automobiles, and table 208 includes data regarding the quality inspection stations. These two tables are referenced by table 212, which includes data regarding the inspections performed, the inspection stations, and the vehicles that were inspected.

Table 208 is referenced table 216, which specifies areas in a manufacturing plant. For example, a manufacturing process for an automobile may include paint, body, and assembly departments, and the assembly department may include trim, chassis, and inspection areas, each of which may have multiple inspection stations. The inspection stations 110 are associated with certain areas of the plant. For example, a chassis line may have four inspection stations.

Table 208 is also referenced by table 220, which includes data regarding the components that an inspection station can inspect. For example, in an automobile manufacturing plant, a station on the trim line may inspect a hood or a door but not an engine. Table 220 also references a table 224, which includes data on components that may be inspected (e.g., hoods, doors, engines, etc. for automobiles). Table 220 may have a variety of relationships (e.g., one-to-one, one-to-many, many-to-one, or many-to-many) between the inspection stations and an item's components.

Data organization 200 also includes a table 228 that specifies the type and location of defects. Table 228 references a table 232 that includes data regarding where defects may occur (e.g., a particular zone on a roof or door), a table 236 that includes data regarding defects for a standard (JD Power in this implementation), and a table 240 that includes data regarding defects about which the manufacturer is concerned (e.g., scratch, dent, hole, missing, non-operational, etc.). The defect data in table 236 may or may not be similar to the defect data in table 240. JD Power, for example, typically tracks fewer defects than an automobile manufacturer tracks. The defect data in table 236 and table 240 may be associated, and in particular implementations, data in table 236 (e.g., JD Power codes) may be automatically selected based on the defects identified in table 240. The defects for the standard may also be associated with a scoring system in which some defects (e.g., scratch v. dent) are more heavily weighted than others (e.g., low, medium, and high). Table 228 also references table 220.

Table 228 may associate the defects and defect locations to prevent unwanted descriptions of defects. For an automobile, for example, it may not be logical to indicate that that a windshield has a dent, that an unpainted part has a scratch in the paint, or that a plastic piece is not properly welded. The associations may be established and updated as needed.

Data organization 200 additionally includes a table 248 that includes data regarding the relationship between components that are subject to quality control and their departments in the plant. For example, in an automotive manufacturing process, a door handle is attached in the assembly department and not the paint department or the body department.

Table 248 references a table 252 and a table 256. Table 252 includes data regarding the plant's departments (e.g., paint, body, and assembly for a vehicle build operation). Table 256 includes data regarding subcomponents of inspected components (e.g., a door includes a handle and a liner). Table 256 references from table 224.

Table 212, table 228, and table 248 are referenced by a table 244. Table 244 includes data regarding inspections and defects for a vehicle and the corresponding departments corresponding to defects. Table 244 may contain one record per defect. Thus, a car having four defects may correspond to four records in table 244.

Using table 244, a variety of queries may be performed to obtain data regarding defects in items being manufactured. The queries may be in any appropriate database query language (e.g., SQL). The queries may be user-formulated or run as part of an automated reporting process. The data may be analyzed to build statistical data regarding defects.

From the results of the queries, additional data regarding the defects in manufactured items may be obtained. For example, additional data regarding the defects (e.g., location), the components in which the defects occur (e.g., door), the item in which the defects occur (e.g., red automobiles), and the shifts in which defects occur may be obtained. For instance, it may be possible to determine at what point in the manufacturing process a particular defect (e.g., paint scratches) is occurring. This may signify a problem with a particular machine or manufacturing process. Additionally, it may be possible to analyze the data to determine that certain defects (e.g., paint scratches) are occurring on a particular shift. This may signify an employee problem (e.g., wearing a large watch) or training problems. The additional data may be obtained through using additional queries or a drill down process into the referenced tables of data organization 200.

Data organization 200 also includes a number of tables for reporting. Tables 260-268 contain summary reports. Table 264 includes data regarding predetermined types of defects. These reports may be run periodically (e.g., daily). Table 260 includes data regarding defects within a given time period (e.g., the last 24 hours). Table 268 includes data regarding reports that may be run, whether automatically or manually.

These types of reports are generally large in an automotive manufacturing plant, where the number of detected defects can be in the multiple tens of thousands per day, and, thus, can take an extended period of time to run. These reports may, for example, be run weekly and purged when out of date. In certain implementations, the reports are run while the plant is off-line.

The reports may be built from table 244. Furthermore, the data may be analyzed more intricately (e.g., drilled into) by retrieving more specific data from the other associated tables.

Tables 272-284 include system-level data for the manufacturing plant. For example, tables 272-276 contain data regarding the items being built. Table 272 references table 276, which includes data regarding object options. Table 280 includes data regarding users that may access the quality assurance system, and table 284 includes data regarding the schedule at the manufacturing plant. Table 280 may, for example, restrict access for particular plant employees to particular inspection stations. Table 280 may also restrict access to system 200 for system administrations and management. Table 284 may, for example, indicate the current shift, when the shift started, and the day with which the shift is associated. In automobile plants, for example, manufacturing processes that occur late in the day (e.g., 11:00 pm) may be associated with the following day.

This example data organization possesses many features. For example, while typical quality assurance data is not consistent and is not made available to the different points in the manufacturing process, this data organization is robust, enabling a much broader range of quality data to be managed through a single point of tracking. Furthermore, even attempting to integrate data from different inspection stations does not necessarily result in having useful data. This data organization, however, uses a model that improves throughput and provides its users faster, more reliable access to quality data containing the content they are seeking. For example, data in a large manufacturing operation may be captured in seconds instead of tens of seconds, allowing more units to be examined. Moreover, informative reports may be generated in seconds instead of minutes. Data is therefore available across the manufacturing process, at multiple stations, so the status of the items can be tracked and made available in real-time. This capability is especially useful for improving overall quality issues. The database may have a user-friendly front-end that makes it simple to establish more robust selection criteria.

The example also has the ability to be integrated with existing quality assurance systems. For example, Cimplicity Tracker, available from GE Fanuc Automation of Charlottesville, Va., is deployed in a number of different manufacturing plants to track items. These manufacturing plants could be a basis for a similar quality database model. The capturing of defects associated with these items at specific locations in the build process could utilize this model to isolate processing times for different locations.

Although FIG. 2 illustrates one implementation of a data organization for quality assurance, other implementations may include fewer or additional tables. For example, an implementation may not include one or more tables such as table 216, table 232, table 236, table 248, table 252, table 256, table 260, table 264, table 268, table 272, table 276, table 280, or table 284. As another example, an implementation may include additional tables similar to tables 260-284.

Below is an example table listing for data organization 200 for use in an automobile manufacturing plant:

| | | | | | |
|---|---|---|---|---|---|
| Table | +-QC_AREA | | | | |
| Column | \|FKDPT_SEQ_NO | Smallint | 3 | Not Null | |
| Column | \|SEQ_NO | Smallint | 3 | Not Null | |
| Column | \|NAME | Varchar | 20 | Not Null | |
| Column | \|DESCRIPTION | Varchar | 30 | Null | |
| Column | \|CREATE_DATE_TIME | Timestamp | 20 | Null | |
| Column | \|UPDATE_DATE_TIME | Timestamp | 20 | Null | |
| Column | \|USERID | Varchar | 8 | Null | |
| Index (U) | \|+-PKAREA | (Primary) | | | |
| Column | \|\|FKDPT_SEQ_NO | Smallint | 3 | Not Null | Asc |
| Column | \|\|SEQ_NO | Smallint | 3 | Not Null | Asc |
| | \|+- | | | | |
| | +- | | | | |
| Table | +-QC_CURRENT_DEFECTS | | | | |
| Column | \|DPT_SEQ_NO | Smallint | 3 | Not Null | |
| Column | \|ARE_SEQ_NO | Smallint | 3 | Not Null | |
| Column | \|STN_SEQ_NO | Smallint | 3 | Not Null | |
| Column | \|ITM_CODE | Integer | 6 | Not Null | |
| Column | \|LCN_SEQ_NO | Smallint | 4 | Not Null | |
| Column | \|DFT_CODE | Integer | 6 | Not Null | |
| Column | \|CURRENT_QTY | Smallint | 3 | Null | |
| Column | \|ALARM_QTY | Smallint | 3 | Null | |
| Index (U) | \|+-PKCURDEF | (Primary) | | | |
| Column | \|\|DPT_SEQ_NO | Smallint | 3 | Not Null | Asc |
| Column | \|\|ARE_SEQ_NO | Smallint | 3 | Not Null | Asc |
| Column | \|\|STN_SEQ_NO | Smallint | 3 | Not Null | Asc |
| Column | \|\|ITM_CODE | Integer | 6 | Not Null | Asc |
| Column | \|\|LCN_SEQ_NO | Smallint | 4 | Not Null | Asc |
| Column | \|\|DFT_CODE | Integer | 6 | Not Null | Asc |
| | \|+- | | | | |
| | +- | | | | |
| Table | +-QC_CURRENT_SCHED | | | | |
| Column | \|FKDPT_SEQ_NO | Smallint | 3 | Not Null | |
| Column | \|AREA_SEQ_NO | Smallint | 3 | Not Null | |
| Column | \|PRODUCTION_DATE | Date | 8 | Not Null | |
| Column | \|SHIFT | Char | 1 | Not Null | |
| Index (U) | \|+-PKCURSCH | (Primary) | | | |
| Column | \|\|AREA_SEQ_NO | Smallint | 3 | Not Null | Asc |
| Column | \|\|FKDPT_SEQ_NO | Smallint | 3 | Not Null | Asc |
| | \|+- | | | | |
| | +- | | | | |
| Table | +-QC_DEFECT | | | | |
| Column | \|CODE | Integer | 6 | Not Null | |
| Column | \|DESCRIPTION | Varchar | 50 | Not Null | |
| Column | \|PRIORITY_LEVEL | Smallint | 2 | Null | |
| Column | \|CREATE_DATE_TIME | Timestamp | 20 | Null | |
| Column | \|UPDATE_DATE_TIME | Timestamp | 20 | Null | |
| Column | \|USERID | Varchar | 8 | Null | |
| Index (U) | \|+-PKDEFECT | (Primary) | | | |
| Column | \|\|CODE | Integer | 6 | Not Null | Asc |
| | \|+- | | | | |
| | +- | | | | |
| Table | +-QC_DEPARTMENT | | | | |
| Column | \|SEQ_NO | Smallint | 3 | Not Null | |
| Column | \|DESCRIPTION | Varchar | 50 | Not Null | |
| Column | \|CREATE_DATE_TIME | Timestamp | 20 | Null | |
| Column | \|UPDATE_DATE_TIME | Timestamp | 20 | Null | |
| Column | \|USERID | Varchar | 8 | Null | |
| Index (U) | \|+-PKDEPT | (Primary) | | | |
| Column | \|\|SEQ_NO | Smallint | 3 | Not Null | Asc |
| | \|+- | | | | |
| | +- | | | | |
| Table | +-QC_DEPT_SUB_ITEM | | | | |
| FK Column | \|FKDPT_SEQ_NO | Smallint | 3 | Not Null | |
| FK Column | \|FKITM_CODE | Integer | 6 | Not Null | |
| FK Column | \|FKSIT_CODE | Integer | 6 | Not Null | |
| Column | \|CREATE_DATE_TIME | Timestamp | 20 | Null | |
| Column | \|USERID | Varchar | 8 | Null | |
| RI Constraint | \|RIDSIDPT QC_DEPARTMENT | | | | |
| RI Constraint | \|RIDSISIT QC_SUB_ITEM | | | | |
| Index (U) | \|+-PKDPTSIT | (Primary) | | | |
| Column | \|\|FKDPT_SEQ_NO | Smallint | 3 | Not Null | Asc |
| Column | \|\|FKITM_CODE | Integer | 6 | Not Null | Asc |
| Column | \|\|FKSIT_CODE | Integer | 6 | Not Null | Asc |
| | \|+- | | | | |
| Index | \|+-FKDPT | | | | |
| Column | \|\|FKDPT_SEQ_NO | Smallint | 3 | Not Null | Asc |
| | \|+- | | | | |
| Index | \|+-FKITM | | | | |
| Column | \|\|FKITM_CODE | Integer | 6 | Not Null | Asc |
| Column | \|\|FKSIT_CODE | Integer | 6 | Not Null | Asc |
| | \|+- | | | | |
| | +- | | | | |
| Table | +-QC_ITEM | | | | |
| Column | \|CODE | Integer | 6 | Not Null | |
| Column | \|DESCRIPTION | Varchar | 50 | Not Null | |
| Column | \|CREATE_DATE_TIME | Timestamp | 20 | Null | |
| Column | \|UPDATE_DATE_TIME | Timestamp | 20 | Null | |
| Column | \|USERID | Varchar | 8 | Null | |
| Index (U) | \|+-PKITEM | (Primary) | | | |
| Column | \|\|CODE | Integer | 6 | Not Null | Asc |
| | \|+- | | | | |
| | +- | | | | |
| Table | +-QC_ITEM_DEFECT_LOC | | | | |
| FK Column | \|FKARE_FKDPT_SEQ_NO | Smallint | 3 | Not Null | |
| FK Column | \|FKARE_SEQ_NO | Smallint | 3 | Not Null | |
| FK Column | \|FKSTN_SEQ_NO | Smallint | 3 | Not Null | |
| FK Column | \|FKITM_CODE | Integer | 6 | Not Null | |
| FK Column | \|FKLCN_SEQ_NO | Smallint | 4 | Not Null | |
| FK Column | \|FKDFT_CODE | Integer | 6 | Not Null | |
| Column | \|DVT_IND | Char | 1 | Null | |
| Column | \|ALARM_QTY | Smallint | 3 | Null | |
| Column | \|ALARM_ACTIVE | Char | 1 | Null | |
| Column | \|CREATE_DATE_TIME | Timestamp | 20 | Null | |
| Column | \|UPDATE_DATE_TIME | Timestamp | 20 | Null | |
| Column | \|USERID | Varchar | 8 | Null | |
| FK Column | \|FKJDP_CODE | Integer | 6 | Null | |
| RI Constraint | \|RIIDLJDP QC_JD_POWER | | | | |
| RI Constraint | \|RIIDLLCN QC_LOCATION | | | | |
| RI Constraint | \|RIIDLDFT QC_DEFECT | | | | |
| RI Constraint | \|RIIDLSTI QC_STATION_ITEM | | | | |
| Index | \|+-FKJDP | | | | |
| Column | \|\|FKJDP_CODE | Integer | 6 | Null | Asc |
| | \|+- | | | | |
| Index (U) | \|+-PKITMDLC | (Primary) | | | |
| Column | \|\|FKARE_FKDPT_SEQ_NO | Smallint | 3 | Not Null | Asc |
| Column | \|\|FKARE_SEQ_NO | Smallint | 3 | Not Null | Asc |
| Column | \|\|FKSTN_SEQ_NO | Smallint | 3 | Not Null | Asc |
| Column | \|\|FKITM_CODE | Integer | 6 | Not Null | Asc |
| Column | \|\|FKLCN_SEQ_NO | Smallint | 4 | Not Null | Asc |
| Column | \|\|FKDFT_CODE | Integer | 6 | Not Null | Asc |
| | \|+- | | | | |
| Index | \|+-FKLCN | | | | |
| Column | \|\|FKLCN_SEQ_NO | Smallint | 4 | Not Null | Asc |
| | \|+- | | | | |
| Index | \|+-FKDFT | | | | |
| Column | \|\|FKDFT_CODE | Integer | 6 | Not Null | Asc |
| | \|+- | | | | |
| Index | \|+-FKARE | | | | |
| Column | \|\|FKARE_FKDPT_SEQ_NO | Smallint | 3 | Not Null | Asc |
| Column | \|\|FKARE_SEQ_NO | Smallint | 3 | Not Null | Asc |
| Column | \|\|FKSTN_SEQ_NO | Smallint | 3 | Not Null | Asc |
| Column | \|\|FKITM_CODE | Integer | 6 | Not Null | Asc |
| | \|+- | | | | |
| | +- | | | | |
| Table | +-QC_JD_POWER | | | | |
| Column | \|CODE | Integer | 6 | Not Null | |
| Column | \|BUCKET_DESCRIPTION | Varchar | 25 | Null | |
| Column | \|CREATE_DATE_TIME | Timestamp | 20 | Null | |
| Column | \|UPDATE_DATE_TIME | Timestamp | 20 | Null | |
| Column | \|USERID | Varchar | 8 | Null | |
| Index (U) | \|+-PKJDPWR | (Primary) | | | |
| Column | \|\|CODE | Integer | 6 | Not Null | Asc |
| | \|+- | | | | |
| | +- | | | | |
| Table | +-QC_LOCATION | | | | |
| Column | \|SEQ_NO | Smallint | 4 | Not Null | |
| Column | \|DESCRIPTION | Varchar | 50 | Not Null | |
| Column | \|CREATE_DATE_TIME | Timestamp | 20 | Null | |
| Column | \|UPDATE_DATE_TIME | Timestamp | 20 | Null | |
| Column | \|USERID | Varchar | 8 | Null | |
| Index (U) | \|+-PKLOCATN | (Primary) | | | |
| Column | \|\|SEQ_NO | Smallint | 4 | Not Null | Asc |
| | \|+- | | | | |
| | +- | | | | |
| Table | +-QC_OVERALL_BUYOFF | | | | |
| Column | \|PRODUCTION_DATE | Timestamp | 20 | Not Null | |
| Column | \|SHIFT | Char | 1 | Not Null | |
| Column | \|BODY_TYPE | Varchar | 4 | Not Null | |
| Column | \|STATION | Varchar | 8 | Not Null | |
| Column | \|OK | Smallint | 3 | Not Null | |
| Column | \|NG | Smallint | 3 | Not Null | |
| Column | \|FTQ | Decimal | 3.2 | Not Null | |
| Column | \|DPV | Decimal | 4.2 | Not Null | |
| Column | \|TOTAL_VEHICLES | Smallint | 4 | Not Null | |
| Column | \|TOTAL_DEFECTS | Smallint | 4 | Not Null | |
| Index (U) | \|+-PKOVRBYF | (Primary) | | | |
| Column | \|\|PRODUCTION_DATE | Timestamp | 20 | Not Null | Asc |
| Column | \|\|SHIFT | Char | 1 | Not Null | Asc |
| Column | \|\|BODY_TYPE | Varchar | 4 | Not Null | Asc |
| Column | \|\|STATION | Varchar | 8 | Not Null | Asc |
| | \|+- | | | | |
| | +- | | | | |
| Table | +-QC_REPORTS | | | | |
| Column | \|NUMBER | Integer | 5 | Not Null | |
| Column | \|GROUP_CODE | Varchar | 10 | Not Null | |
| Column | \|DESCRIPTION | Varchar | 50 | Not Null | |
| Column | \|SYSTEM_CODE | Char | 1 | Not Null | |
| Column | \|QUERY_STRING | Varchar | 255 | Not Null | |
| Column | \|REPORT_NAME | Varchar | 50 | Not Null | |
| Column | \|SP_NAME | Long Varchar | 266 | Not Null | |
| Index (U) | \|+-PKREPORT | (Primary) | | | |
| Column | \|\|NUMBER | Integer | 5 | Not Null | Asc |
| | \|+- | | | | |
| | +- | | | | |
| Table | +-QC_STATION | | | | |
| FK Column | \|FKARE_FKDPT_SEQ_NO | Smallint | 3 | Not Null | |
| FK Column | \|FKARE_SEQ_NO | Smallint | 3 | Not Null | |
| Column | \|SEQ_NO | Smallint | 3 | Not Null | |
| Column | \|DESCRIPTION | Varchar | 25 | Not Null | |
| Column | \|CREATE_DATE_TIME | Timestamp | 20 | Null | |
| Column | \|UPDATE_DATE_TIME | Timestamp | 20 | Null | |
| Column | \|USERID | Varchar | 8 | Null | |
| RI Constraint | \|RISTNARE QC_AREA | | | | |
| Index (U) | \|+-PKSTATN | (Primary) | | | |
| Column | \|\|FKARE_FKDPT_SEQ_NO | Smallint | 3 | Not Null | Asc |
| Column | \|\|FKARE_SEQ_NO | Smallint | 3 | Not Null | Asc |
| Column | \|\|SEQ_NO | Smallint | 3 | Not Null | Asc |
| | \|+- | | | | |
| | +- | | | | |
| Table | +-QC_STATION_ITEM | | | | |
| FK Column | \|FKARE_FKDPT_SEQ_NO | Smallint | 3 | Not Null | |
| FK Column | \|FKARE_SEQ_NO | Smallint | 3 | Not Null | |
| FK Column | \|FKSTN_SEQ_NO | Smallint | 3 | Not Null | |
| FK Column | \|FKITM_CODE | Integer | 6 | Not Null | |
| Column | \|CREATE_DATE_TIME | Timestamp | 20 | Null | |
| Column | \|USERID | Varchar | 8 | Null | |
| RI Constraint | \|RISTISTN QC_STATION | | | | |
| RI Constraint | \|RISTIITM QC_ITEM | | | | |
| Index (U) | \|+-PKSTNITM | (Primary) | | | |
| Column | \|\|FKARE_FKDPT_SEQ_NO | Smallint | 3 | Not Null | Asc |
| Column | \|\|FKARE_SEQ_NO | Smallint | 3 | Not Null | Asc |
| Column | \|\|FKSTN_SEQ_NO | Smallint | 3 | Not Null | Asc |
| Column | \|\|FKITM_CODE | Integer | 6 | Not Null | Asc |
| | \|+- | | | | |
| Index | \|+-FKSTN | | | | |
| Column | \|\|FKARE_FKDPT_SEQ_NO | Smallint | 3 | Not Null | Asc |
| Column | \|\|FKARE_SEQ_NO | Smallint | 3 | Not Null | Asc |
| Column | \|\|FKSTN_SEQ_NO | Smallint | 3 | Not Null | Asc |
| | \|+- | | | | |
| Index | \|+-FKITEM | | | | |
| Column | \|\|FKITM_CODE | Integer | 6 | Not Null | Asc |
| | \|+- | | | | |
| | +- | | | | |
| Table | +-QC_SUB_ITEM | | | | |
| FK Column | \|FKITM_CODE | Integer | 6 | Not Null | |
| Column | \|CODE | Integer | 6 | Not Null | |
| Column | \|DESCRIPTION | Varchar | 50 | Not Null | |
| Column | \|CREATE_DATE_TIME | Timestamp | 20 | Null | |
| Column | \|UPDATE_DATE_TIME | Timestamp | 20 | Null | |
| Column | \|USERID | Varchar | 8 | Null | |
| RI Constraint | \|RISITITM QC_ITEM | | | | |
| Index (U) | \|+-PKSUBITM | (Primary) | | | |
| Column | \|\|FKITM_CODE | Integer | 6 | Not Null | Asc |
| Column | \|\|CODE | Integer | 6 | Not Null | Asc |
| | \|+- | | | | |
| | +- | | | | |
| Table | +-QC_USERS | | | | |
| Column | \|SYSTEM_USERID | Varchar | 8 | Not Null | |
| Column | \|FKDEPT | Smallint | 3 | Not Null | |
| Column | \|FIRST_NAME | Varchar | 15 | Null | |
| Column | \|SURNAME | Varchar | 20 | Null | |
| Column | \|ACCESS_LEVEL | Smallint | 1 | Null | |
| Column | \|CREATE_DATE_TIME | Timestamp | 20 | Null | |
| Column | \|UPDATE_DATE_TIME | Timestamp | 20 | Null | |
| Column | \|USERID | Varchar | 8 | Null | |
| Index (U) | \|+-PKUSERS | (Primary) | | | |
| Column | \|\|SYSTEM_USERID | Varchar | 8 | Not Null | Asc |
| | \|+- | | | | |
| | +- | | | | |
| Table | +-QC_VEHICLE | | | | |
| Column | \|PVI | Varchar | 9 | Not Null | |
| Column | \|MODEL | Varchar | 7 | Not Null | |
| Column | \|COLOUR_UPPER | Varchar | 6 | Not Null | |
| Column | \|COLOUR_SPECIAL | Varchar | 6 | Null | |
| Column | \|COLOUR_LOWER | Varchar | 6 | Null | |
| Column | \|COLOUR_TRIM | Varchar | 6 | Null | |
| Column | \|PLANT | Varchar | 4 | Null | |
| Column | \|BODY_TYPE | Varchar | 4 | Null | |
| Column | \|DRIVE_TRAIN | Varchar | 20 | Null | |
| Column | \|VIN | Varchar | 17 | Null | |
| Index (U) | \|+-PKVEHCLE | (Primary) | | | |
| Column | \|\|PVI | Varchar | 9 | Not Null | Asc |
| | \|+- | | | | |
| | +- | | | | |
| Table | +-QC_VEHICLE_DEF | | | | |
| FK Column | \|FKARE_FKDPT_SEQ_NO | Smallint | 3 | Not Null | |
| FK Column | \|FKARE_SEQ_NO | Smallint | 3 | Not Null | |
| FK Column | \|FKSTN_SEQ_NO | Smallint | 3 | Not Null | |
| FK Column | \|FKITM_CODE | Integer | 6 | Not Null | |
| FK Column | \|FKLCN_SEQ_NO | Smallint | 4 | Not Null | |
| FK Column | \|FKDFT_CODE | Integer | 6 | Not Null | |
| FK Column | \|FKAR1_FKDPT_SEQ_NO | Smallint | 3 | Not Null | |
| FK Column | \|FKAR1_SEQ_NO | Smallint | 3 | Not Null | |
| FK Column | \|FKST1_SEQ_NO | Smallint | 3 | Not Null | |
| FK Column | \|FKVEH_PVI | Varchar | 9 | Not Null | |
| FK Column | \|FKVIN_INSPECT_DATE | Timestamp | 20 | Not Null | |
| FK Column | \|FKDPT_SEQ_NO | Smallint | 3 | Not Null | |
| FK Column | \|FKIT1_CODE | Integer | 6 | Not Null | |
| FK Column | \|FKSIT_CODE | Integer | 6 | Not Null | |
| Column | \|REPAIRED | Varchar | 1 | Null | |
| Column | \|X_COORDINATE | Smallint | 3 | Null | |
| Column | \|Y_COORDINATE | Smallint | 3 | Null | |
| Column | \|ASSIGNED_DEPT | Smallint | 3 | Null | |
| Column | \|BUYOFF_DESCRIPTION | Varchar | 200 | Null | |
| Column | \|CREATE_DATE_TIME | Timestamp | 20 | Null | |
| Column | \|UPDATE_DATE_TIME | Timestamp | 20 | Null | |
| Column | \|USERID | Varchar | 8 | Null | |
| RI Constraint | \|RIVDFDSI QC_DEPT_SUB_ITEM | | | | |
| RI Constraint | \|RIVDFIDL QC_ITEM_DEFECT_LOC | | | | |
| RI Constraint | \|RIVDFVIN QC_VEHICLE_INSPECT | | | | |
| Index (U) | \|+-PKVEHDEF | (Primary) | | | |
| Column | \|\|FKARE_FKDPT_SEQ_NO | Smallint | 3 | Not Null | Asc |
| Column | \|\|FKARE_SEQ_NO | Smallint | 3 | Not Null | Asc |
| Column | \|\|FKSTN_SEQ_NO | Smallint | 3 | Not Null | Asc |
| Column | \|\|FKITM_CODE | Integer | 6 | Not Null | Asc |
| Column | \|\|FKLCN_SEQ_NO | Smallint | 4 | Not Null | Asc |
| Column | \|\|FKDFT_CODE | Integer | 6 | Not Null | Asc |
| Column | \|\|FKAR1_FKDPT_SEQ_NO | Smallint | 3 | Not Null | Asc |
| Column | \|\|FKAR1_SEQ_NO | Smallint | 3 | Not Null | Asc |
| Column | \|\|FKST1_SEQ_NO | Smallint | 3 | Not Null | Asc |
| Column | \|\|FKVEH_PVI | Varchar | 9 | Not Null | Asc |
| Column | \|\|FKVIN_INSPECT_DATE | Timestamp | 20 | Not Null | Asc |
| Column | \|\|FKDPT_SEQ_NO | Smallint | 3 | Not Null | Asc |
| Column | \|\|FKIT1_CODE | Integer | 6 | Not Null | Asc |
| Column | \|\|FKSIT_CODE | Integer | 6 | Not Null | Asc |
| | \|+- | | | | |
| Index | \|+-FKDSI | | | | |
| Column | \|\|FKDPT_SEQ_NO | Smallint | 3 | Not Null | Asc |
| Column | \|\|FKIT1_CODE | Integer | 6 | Not Null | Asc |
| Column | \|\|FKSIT_CODE | Integer | 6 | Not Null | Asc |
| | \|+- | | | | |
| Index | \|+-FKIDL | | | | |
| Column | \|\|FKARE_FKDPT_SEQ_NO | Smallint | 3 | Not Null | Asc |
| Column | \|\|FKARE_SEQ_NO | Smallint | 3 | Not Null | Asc |
| Column | \|\|FKSTN_SEQ_NO | Smallint | 3 | Not Null | Asc |
| Column | \|\|FKITM_CODE | Integer | 6 | Not Null | Asc |
| Column | \|\|FKLCN_SEQ_NO | Smallint | 4 | Not Null | Asc |
| Column | \|\|FKDFT_CODE | Integer | 6 | Not Null | Asc |
| | \|+- | | | | |
| Index | \|+-FKVIN | | | | |
| Column | \|\|FKAR1_FKDPT_SEQ_NO | Smallint | 3 | Not Null | Asc |
| Column | \|\|FKAR1_SEQ_NO | Smallint | 3 | Not Null | Asc |
| Column | \|\|FKST1_SEQ_NO | Smallint | 3 | Not Null | Asc |
| Column | \|\|FKVEH_PVI | Varchar | 9 | Not Null | Asc |
| Column | \|\|FKVIN_INSPECT_DATE | Timestamp | 20 | Not Null | Asc |
| | \|+- | | | | |
| | +- | | | | |
| Table | +-QC_VEHICLE_INSPECT | | | | |
| FK Column | \|FKARE_FKDPT_SEQ_NO | Smallint | 3 | Not Null | |
| FK Column | \|FKARE_SEQ_NO | Smallint | 3 | Not Null | |
| FK Column | \|FKSTN_SEQ_NO | Smallint | 3 | Not Null | |
| FK Column | \|FKVEH_PVI | Varchar | 9 | Not Null | |
| Column | \|INSPECTION_DATE | Timestamp | 20 | Not Null | |
| Column | \|SHIFT | Varchar | 1 | Not Null | |
| Column | \|JUDGE | Varchar | 1 | Not Null | |
| Column | \|INSPECTOR | Varchar | 4 | Not Null | |
| Column | \|CURRENT_SCHED_DATE | Timestamp | 20 | Null | |
| Column | \|ORIG_INSPECT_DATE | Timestamp | 20 | Null | |
| Column | \|ORIG_SCHED_DATE | Timestamp | 20 | Null | |
| Column | \|ORIG_SHIFT | Varchar | 1 | Null | |
| Column | \|CREATE_DATE_TIME | Timestamp | 20 | Null | |
| Column | \|UPDATE_DATE_TIME | Timestamp | 20 | Null | |
| Column | \|USERID | Varchar | 8 | Null | |
| RI Constraint | \|RIVINSTN QC_STATION | | | | |
| RI Constraint | \|RIVINVEH QC_VEHICLE | | | | |
| Index (U) | \|+-PKVEHINS | (Primary) | | | |
| Column | \|\|FKARE_FKDPT_SEQ_NO | Smallint | 3 | Not Null | Asc |
| Column | \|\|FKARE_SEQ_NO | Smallint | 3 | Not Null | Asc |
| Column | \|\|FKSTN_SEQ_NO | Smallint | 3 | Not Null | Asc |
| Column | \|\|FKVEH_PVI | Varchar | 9 | Not Null | Asc |
| Column | \|\|INSPECTION_DATE | Timestamp | 20 | Not Null | Asc |
| | \|+- | | | | |
| Index | \|+-FKSTN1 | | | | |
| Column | \|\|FKARE_FKDPT_SEQ_NO | Smallint | 3 | Not Null | Asc |
| Column | \|\|FKARE_SEQ_NO | Smallint | 3 | Not Null | Asc |
| Column | \|\|FKSTN_SEQ_NO | Smallint | 3 | Not Null | Asc |
| | \|+- | | | | |
| Index | \|+-FKVEH | | | | |
| Column | \|\|FKVEH_PVI | Varchar | 9 | Not Null | Asc |
| | \|+- | | | | |
| | +- | | | | |

Table 1 provides more information regarding several of the fields in the above listing.

TABLE 1

| Field | Subject Area | Table | Description |
|---|---|---|---|
| FKDPT_SEQ_NO | INSPECTION | QC_AREA | Department assigned to the |
| | | | area. |
| SEQ_NO | INSPECTION | QC_AREA | System assigned number to |
| | | | uniquely identify the key for |
| | | | the table. |
| NAME | INSPECTION | QC_AREA | This is the name that is |
| | | | assigned to a particular group |
| | | | of stations. This name is used |
| | | | to assign a station to a |
| | | | particular group of stations for |
| | | | the various reports (e.g., Trim |
| | | | Line). |
| DESCRIPTION | INSPECTION | QC_AREA | Full descriptive explanation |
| | | | for the area name. |
| CREATE_DATE_TIME | INSPECTION | QC_AREA | The date and time the record |
| | | | was created. |
| UPDATE_DATE_TIME | INSPECTION | QC_AREA | The date and time the record |
| | | | was last updated. |
| USERID | INSPECTION | QC_AREA | The system logon id of the |
| | | | user. |
| DPT_SEQ_NO | SUMMARIES | QC_CURRENT_DEFECTS | Department assigned to the |
| | | | area. |
| ARE_SEQ_NO | SUMMARIES | QC_CURRENT_DEFECTS | System assigned number to |
| | | | uniquely identify the key for |
| | | | the table. |
| CURRENT_QTY | SUMMARIES | QC_CURRENT_DEFECTS | The number of defects that |
| | | | have occurred for this current |
| | | | defect. |
| ALARM_QTY | SUMMARIES | QC_CURRENT_DEFECTS | The number of defects that |
| | | | need to occur for this to cause |
| | | | an alarm to occur. |
| FKDPT_SEQ_NO | SYSTEM | QC_CURRENT_SCHED | Department assigned to the |
| | | | area. |
| AREA_SEQ_NO | SYSTEM | QC_CURRENT_SCHED | System assigned number to |
| | | | uniquely identify the key for |
| | | | the table. |
| PRODUCTION_DATE | SYSTEM | QC_CURRENT_SCHED | The current production date |
| | | | for the selected |
| | | | department/area combination. |
| SHIFT | SYSTEM | QC_CURRENT_SCHED | The current production shift |
| | | | for the selected |
| | | | department/area combination. |
| CREATE_DATE_TIME | VEHICLE | QC_DEFECT | The date and time the record |
| | | | was created. |
| UPDATE_DATE_TIME | VEHICLE | QC_DEFECT | The date and time the record |
| | | | was last updated. |
| USERID | VEHICLE | QC_DEFECT | The system logon id of the |
| | | | user. |
| CREATE_DATE_TIME | INSPECTION | QC_DEPARTMENT | The date and time the record |
| | | | was created. |
| UPDATE_DATE_TIME | INSPECTION | QC_DEPARTMENT | The date and time the record |
| | | | was last updated. |
| USERID | INSPECTION | QC_DEPARTMENT | The system logon ID of the |
| | | | user. |
| CREATE_DATE_TIME | INSPECTION | QC_DEPT_SUB_ITEM | The date and time the record |
| | | | was created. |
| USERID | INSPECTION | QC_DEPT_SUB_ITEM | The system logon ID of the |
| | | | user. |
| CREATE_DATE_TIME | INSPECTION | QC_ITEM | The date and time the record |
| | | | was created. |
| UPDATE_DATE_TIME | INSPECTION | QC_ITEM | The date and time the record |
| | | | was last updated. |
| USERID | INSPECTION | QC_ITEM | The system logon ID of the |
| | | | user. |
| DVT_IND | VEHICLE | QC_ITEM_DEFECT_LOCATION | Indicator to classify this item |
| | | | defect for this location as a |
| | | | DVT defect. |
| ALARM_QTY | VEHICLE | QC_ITEM_DEFECT_LOCATION | The number of defects that |
| | | | need to occur for this to cause |
| | | | an alarm to be generated per |
| | | | shift. |
| ALARM_ACTIVE | VEHICLE | QC_ITEM_DEFECT_LOCATION | Is the alarm active for this |
| | | | defect location item? (Y or N) |
| CREATE_DATE_TIME | VEHICLE | QC_ITEM_DEFECT_LOCATION | The date and time the record |
| | | | was created. |
| UPDATE_DATE_TIME | VEHICLE | QC_ITEM_DEFECT_LOCATION | The date and time the record |
| | | | was last updated. |
| USERID | VEHICLE | QC_ITEM_DEFECT_LOCATION | The system logon ID of the |
| | | | user. |
| CREATE_DATE_TIME | VEHICLE | QC_JD_POWER | The date and time the record |
| | | | was created. |
| UPDATE_DATE_TIME | VEHICLE | QC_JD_POWER | The date and time the record |
| | | | was last updated. |
| USERID | VEHICLE | QC_JD_POWER | The system logon ID of the |
| | | | user. |
| CREATE_DATE_TIME | VEHICLE | QC_LOCATION | The date and time the record |
| | | | was created. |
| UPDATE_DATE_TIME | VEHICLE | QC_LOCATION | The date and time the record |
| | | | was last updated. |
| USERID | VEHICLE | QC_LOCATION | The system logon ID of the |
| | | | user. |
| SEQ_NO | INSPECTION | QC_STATION | Station identifier. |
| WRK_STN | INSPECTION | QC_STATION | The workstation number that |
| | | | the station is. |
| RESOURCE | INSPECTION | QC_STATION | The Cimplicity Resource that |
| | | | the station is assigned to. |
| CREATE_DATE_TIME | INSPECTION | QC_STATION | The date and time the record |
| | | | was created. |
| UPDATE_DATE_TIME | INSPECTION | QC_STATION | The date and time the record |
| | | | was last updated. |
| USERID | INSPECTION | QC_STATION | The system logon ID of the |
| | | | user. |
| CREATE_DATE_TIME | INSPECTION | QC_STATION_ITEM | The date and time the record |
| | | | was created. |
| USERID | INSPECTION | QC_STATION_ITEM | The system logon ID of the |
| | | | user. |
| CREATE_DATE_TIME | INSPECTION | QC_SUB_ITEM | The date and time the record |
| | | | was created. |
| UPDATE_DATE_TIME | INSPECTION | QC_SUB_ITEM | The date and time the record |
| | | | was last updated. |
| USERID | INSPECTION | QC_SUB_ITEM | The system logon ID of the |
| | | | user. |
| SYSTEM_USERID | SYSTEM | QC_USERS | The system logon ID of the |
| | | | user. May be employee |
| | | | number. |
| FKDEPT | SYSTEM | QC_USERS | Department assigned to the |
| | | | user. |
| FIRST_NAME | SYSTEM | QC_USERS | A user's first name. |
| SURNAME | SYSTEM | QC_USERS | A use's last name. |
| ACCESS_LEVEL | SYSTEM | QC_USERS | The level of access the user |
| | | | will have to the different |
| | | | functionality in the system: 1 = Enter |
| | | | defects for the |
| | | | Department; 2 = Buyoff |
| | | | defects previously entered for |
| | | | the Department; 3 = Enter and |
| | | | buyoff defects for all |
| | | | departments. |
| CREATE_DATE_TIME | SYSTEM | QC_USERS | The date and time the record |
| | | | was created. |
| UPDATE_DATE_TIME | SYSTEM | QC_USERS | The date and time the record |
| | | | was last updated. |
| USERID | SYSTEM | QC_USERS | The system logon ID of the |
| | | | user. |
| REPAIRED | VEHICLE | QC_VEHICLE_DEF | An indicator that states |
| | | | whether this defect has been |
| | | | repaired (i.e. Buyoff): N - still |
| | | | outstanding pending repair; Y - |
| | | | Buyoff has occurred - |
| | | | repaired. |
| X_COORDINATE | VEHICLE | QC_VEHICLE_DEF | The x-value coordinate of the |
| | | | location of the defect based on |
| | | | where the user clicked the |
| | | | object. |
| Y_COORDINATE | VEHICLE | QC_VEHICLE_DEF | The y-value coordinate of the |
| | | | location of the defect based on |
| | | | where the user clicked the |
| | | | object. |
| BUYOFF_DESCRIPTION | VEHICLE | QC_VEHICLE_DEF | A verbal description that can |
| | | | be entered by the user |
| | | | describing the repair process |
| | | | for the defect. |
| CREATE_DATE_TIME | VEHICLE | QC_VEHICLE_DEF | The date and time the record |
| | | | was created. |
| UPDATE_DATE_TIME | VEHICLE | QC_VEHICLE_DEF | The date and time the record |
| | | | was last updated. |
| CREATE_USERID | VEHICLE | QC_VEHICLE_DEF | The system logon ID of the |
| | | | user. |
| BUYOFF_USERID | VEHICLE | QC_VEHICLE_DEF | The system logon ID of the |
| | | | user. |
| CREATE_DATE_TIME | VEHICLE | QC_VEHICLE_INSPECTION | The date and time the record |
| | | | was created. |
| UPDATE_DATE_TIME | VEHICLE | QC_VEHICLE_INSPECTION | The date and time the record |
| | | | was last updated. |
| USERID | VEHICLE | QC_VEHICLE_INSPECTION | The system logon ID of the |
| | | | user. |

This example data organization includes many common elements of relational databases. For example, the tables include super keys, which can be used to uniquely identify the records (e.g., rows) in the tables. Additionally, the tables include foreign keys, which can be used to link the data in one table to another table.

In table 240 (“QC_DEFECT”), for instance, data regarding defects in automobiles is stored. Each defect is assigned a code (“CODE”), a description (“DESCRIPTION”), and a priority level (“PRIORITY_LEVEL”). Thus, appropriate codes may be identified at inspection stations when defects are noted, and the codes may be classified according to their importance. Additionally, table 240 includes the creation time of the code entry (“CREATE_DATE_TIME”), its last update time (“UPDATE_DATE_TIME”), and the log on identification of the user (e.g., employee identifier) that created/modified the location code. The primary key for table 240 is the defect code.

In table 232 (“QC_LOCATION), data regarding the location of defects in automobiles is stored. Each location is assigned a sequence number (“SEQ_NO”) and a description (“DESCRIPTION”). Additionally, table 232 includes the time of creating (“CREATE_DATE_TIME”) and updating a location (“UPDATE_DATE_TIME”). Table 232 also includes a user identifier (“USERID”) in order to identify the employee (e.g., by employee ID) that created/modified the location entry. The primary key for table 232 is the location sequence number.

The sequence number in table 232 and defect codes in table 240 are used by table 228 (“QC_ITEM_DEFECT_LOCATION”), along with data from table 208 (“QC_STATION”), and table 224 (“QC_ITEM”), and table 236 (“QC_JD_POWER”). Table 232 includes foreign keys that refer back to other tables in the data organization. A foreign key is basically a referential constraint between two tables. The foreign key generally identifies a column (or a set of columns) in one table (the referencing table) that refers to a column (or set of columns) in another table (the referenced table). In this example, the foreign keys refer back to table 208, table 216, table 224, table 232, and table 240. For instance, the foreign key that refers back to table 232 is entitled “FKLCN_SEQ_NO,” and the foreign key that refers back to table 240 is entitled “FKDFT_CODE.” The foreign keys are, in general, primary keys from the referenced tables. The foreign keys also form the primary key for table 232.

Table 228 also includes additional data. For example, the table includes data regarding the classification of defects (“DVT_IND”), a number of defects needed to generate an alarm for a particular defect (“ALARM_QTY”), and whether the alarm is active for a particular defect (“ALARM_ACTIVE”).

Table 228 additionally includes relational constraints, which basically form a logical schema. In this example, the relational constraints keep data from table 220, table 232, table 236, table 240 properly associated. For example, the defect locations in table 232 may be properly tied to the defects in table 240, and the defects in table 240 may be properly tied to the industry codes in table 236. Other relations, of course, may be expressed.

In general, the rest of tables 204-256 possess similar structures to those just discussed. For example, table 244 includes data regarding the defects for each vehicle being manufactured by using foreign keys (e.g., FKARE_FKDPT_SEQ_NO, FKARE_SEQ_NO, FKSTN_SEQ_NO, FKITM_CODE, FKLCN_SEQ_NO, FKDFT_CODE, etc.) to reference data in other tables in the data organization. This data allows table 244 to act as a point that summarizes the data regarding the defects. Furthermore, table 244 includes a primary key, which is composed of the foreign keys. From this point, useful reports may be generated. Moreover, more detailed data regarding defect may be uncovered.

Table 244 also includes data regarding repairs to defects. For example, table 244 includes data regarding whether the defect has been repaired (“REPAIRED”), the detailed location of the defect (“X_COORDINATE” and “Y_COORDINATE”), the department assigned to correct the defect (“ASSIGNED_DEPT”), an identifier for the employee repairing the defect (“USERID”), and a description of the repair process (“BUYOFF_DESCRIPTION”).

This example of data organization 200 also include report tables. For example, table 264 (“QC_CURRENT_DEFECTS”) is a summary table including data regarding defects, such as the department associated with a defect (e.g., “DPT_SEQ_NO”), an assigned number for a defect incident (“ARE_SEQ_NO”), the inspection station that found a defect (“STN_SQN_NO”), the item in which a defect occurred (“ITM_CODE”), the location of a defect (“LCN_SEQ_NO”), the number of defects of this type (“CURRENT_QTY”), and the alarm quantity for defects of this type (“ALARM_QTY”). As another example, table 260 (“QC_OVERALL_BUYOFF”) is a production summary table with data regarding the number of vehicle defects (“TOTAL_DEFECTS”) per production day (“PRODUCTION_DATE”), shift (“SHIFT”), and type of vehicle (“BODY_TYPE”). Table 268 (“QC_REPORTS”) includes standard reports that can be run on the data in the data organization.

This example of data organization 200 also includes tables to assist in managing the manufacturing process. For example, table 280 (“QC_USERS”) restricts access to the quality assurance system to authorized employees, and table 284 (“QC_CURRENT_SCHED”) defines what production date and shift is currently underway. Table 272 (“VR_VEH_BUILD_INFO”) and table 276 (“VR_BROADCAST_CODES”) work together to describe the vehicle currently being built.

Although the listing illustrates one example of data organization 200, other listings could contain a variety of different organizations and/or types of data, especially when used for other types of manufacturing plants. For example, certain data types may be added or deleted from certain tables. Moreover, other super keys, foreign keys, and relational constraints could be used. Thus, the listing is only meant to illustrate what data organization 200 could be like.

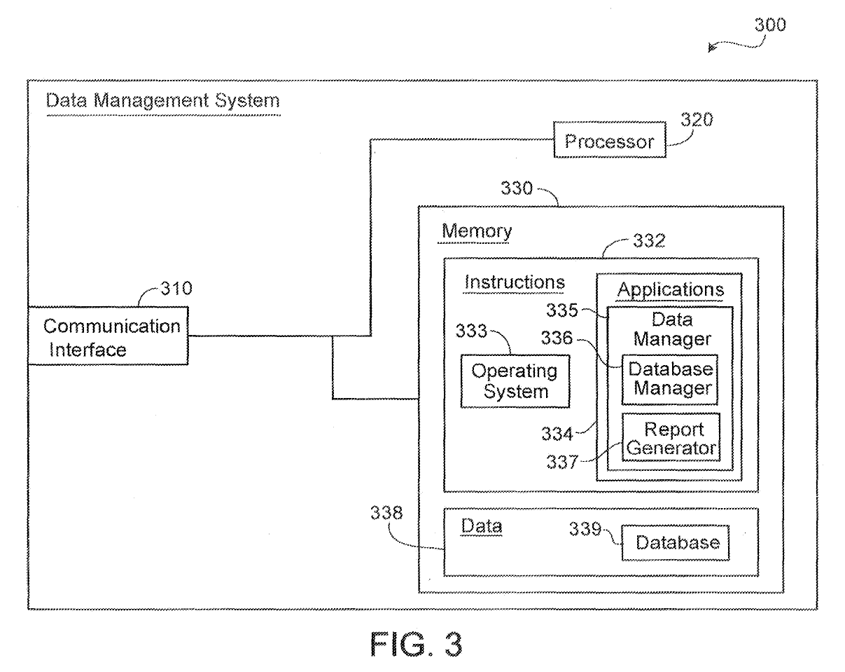

FIG. 3 illustrates one example of a data management system 300. Data management system 300 may, for example, be similar to data management system 120 of system 100.

Data manager 300 includes a communication interface 310, a processor 320, and memory 330. Communication interface 310 receives data from and sends data to a communication network. In particular, communication interface 310 conveys data regarding an item that is being manufactured to and from inspection stations using the communication network. The data is stored in memory 330 and manipulated by processor 330 to compile appropriate quality assurance reports.

Communication interface 310 may be any appropriate device for receiving information from and sending information to a communication network. For example, communication interface may be a modem (e.g., Hayes compatible), a network interface card (e.g., Ethernet card), or a wireless transceiver (e.g., IEEE 802.11 gateway).

Processor 320 may include one or more information manipulation devices. For example, processor 320 may include one or more microprocessors, microcontrollers, ASICS, or any other appropriate devices for manipulating information in a logical manner. Processor 320 may generally include none, some, or all of the instructions for manipulating the data from inspection stations. In the current illustration, for, example, the instructions are stored in memory 330.

Memory 330 includes instructions 332 and data 338. As illustrated, instructions 332 include an operating system 333 (e.g., Windows, Linux, or Unix) and applications 334. Applications 334 include a data manager 335, which includes a database manager 336 (e.g. SQL, Access, or Oracle) and a report generator 337. Data 338 includes a database 339 for the item defects. Database 339 may be similar to data organization 200, for example. Memory 330 may be composed of random access memory (RAM), read-only memory (ROM), compact-disc read-only memory (CD-ROM), registers, and/or any other appropriate device for storing information.

In one mode of operation, data management system 300 provides management functionality to inspection stations and quality assurance for items that are being manufactured. For the inspection stations, for example, data management system 300 may prevent improper associations of data. For instance, database 339 may specify allowable associations between data (e.g., inspection station v. component, component v. defect, defect v. location, etc.). This may prevent inspection stations from reporting improper or impossible defect data. Additionally, the data management system may insure that the relevant data for a defect (e.g., type and location) is obtained. This may allow the data management system to produce more accurate reports.

In regards to quality assurance, data management system 300 may assimilate quality assurance data in database 339 and perform, in response to user-formed queries or automated queries, a variety of queries on the quality assurance data. The operations for and on database 339 may be performed by processor 320 in accordance with the instructions in data manager 335. In particular, the queries may relate to data regarding defects in items being manufactured. In certain implementations, the data for automated queries may be reported in specially designated tables, such as for predetermined types of defects. These reports may be run periodically (e.g., daily). Report generator 337 may be responsible for running these reports.

From the results of the queries, additional data regarding the defects in manufactured items may be obtained. For example, additional data regarding the defects (e.g., location), the components in which the defects occur (e.g., door), the item in which the defects occur (e.g., red automobiles), and the shifts in which defects occur may be obtained. It may be possible, for instance, to determine at what point in the manufacturing process a particular defect (e.g., paint scratches) is occurring. This may signify a problem with a particular machine or manufacturing process. Additionally, it may be possible to analyze the data to determine that certain defects (e.g., paint scratches) are occurring on a particular shift. This may signify an employee problem (e.g., wearing a large watch) or training problems. The additional data may obtained through using additional queries or a drill down process into the related tables of database 339.

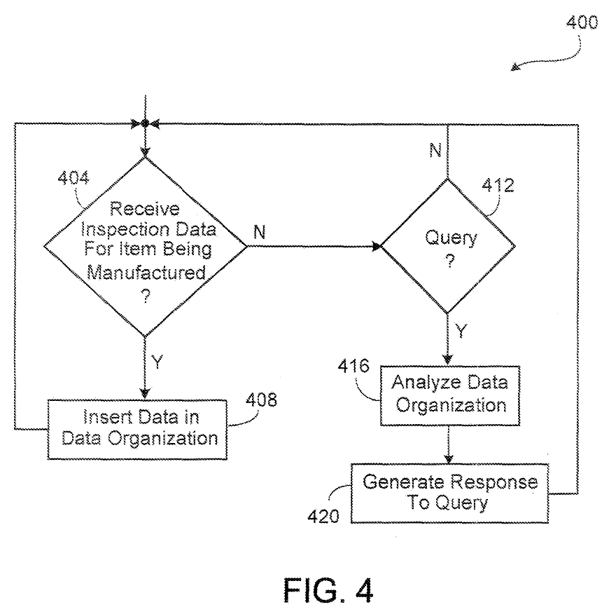

FIG. 4 illustrates one example of a process 400 for providing quality assurance. Process 400 may, for example, illustrate the operations of a data management system such as data management system 120.

Process 400 begins with determining whether inspection data regarding an item being manufactured has been received (operation 404). The inspection data may be from one or more inspection stations located at various points of a manufacturing plant. The inspection stations may acquire the data by manual or automated techniques. The inspection data may be received in response to a request for the data (e.g., a poll) or in response to the inspection stations sending the data on their own (e.g., a upload).

If inspection data has been received, process 400 calls for inserting the data into a data organization (operation 408). The data organization may, for example, be a relational database. Inserting data in the data organization may compile and/or facilitate compiling data regarding defects in the manufacturing process. Process 400 also calls for checking for additional inspection data (operation 404)

If inspection data has not been received, process 400 calls for determining whether a query is to be run (operation 412). A query may, for example, be run if it is time to run the query, if an event has triggered the running of the query, or if a user has input the query. If a query is not to be run, process 400 calls for checking for additional inspection data (operation 404).

If, however, a query is to be run, the data in the data organization is analyzed (operation 416). For example, the data may be analyzed to identify defects occurring in a time period (e.g., 24 hours), a particular type of item (e.g., a red car) or a particular component (e.g., a door) of items. Using the results of the queries, responses to the queries may be generated (operation 420). The responses may, for example, be in the form of reports and may be provided to a user of the system through a hard-copy report, a display or otherwise. The responses may facilitate determining which types of items the defects are occurring on (e.g., red automobiles), when the defects are occurring (e.g., during a particular shift), or where the defects are occurring (e.g., in a particular department). Once the response has been generated, process 400 calls for continuing to check for data from the inspection stations regarding the item being manufactured (operation 404).

The inspection data for an item may be received during the course of many queries. Moreover, inspection data for multiple items being manufactured may be contemporaneously received.

Although FIG. 4 illustrates one example of a process for quality assurance, other processes for quality assurance may include fewer, additional, and/or different arrangements of operations. For example, a quality assurance process may include receiving requests for inspection data (e.g., defects, defect locations, etc.), providing the data, and receiving selected data for the item being manufactured. As another example, a process may include determining whether particular inspection data is properly associated with other inspection data (e.g., defect v. component, component v. inspection station, etc.). As a further example, a process may not include checking for whether a query is to be run. This may, for instance, occur if the data organization provides the appropriate data. As an additional example, a process may call for managing access to the data organization.

Various implementations of the systems and techniques described herein can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the term “machine-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user by an output device can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system may include clients and servers. A client and server are generally remote from each other and typically interact through a communication network. The relationship of client and server arises by virtue of computer programs running on the respective computers and having a client-server relationship to each other.

A number of implementations for assuring quality have been discussed, and several others have been mentioned or suggested. Furthermore, a variety of additions, deletions, substitutions, and/or modifications to these implementations will be readily suggested to those skilled in the art while still achieving quality assurance. Thus, the scope of protection is to judged based on the following claims, which may encompass one or more aspects of one or more implementations.

1. A quality control system for a manufacturing process, the system comprising:
a plurality of inspection stations for receiving data regarding an item that is being manufactured, the item having a plurality of components; and
a data management system coupled to the inspection stations, the data management system comprising:
a data manager operable to generate responses to queries by using a data organization comprising:
a first data structure for capturing identification data regarding the item being manufactured and the inspections for the item;
a second data structure for capturing data regarding defects in the components of the item;
a third data structure for capturing data regarding the components of the item; and
a fourth data structure linked to the first, second, and third data structures for capturing data regarding the item, the inspections for the item, the defects for the components of the item, and the components containing the defects.

2. The system of claim 1, wherein the first data structure is linked to a fifth data structure and a sixth data structure, the fifth data structure for capturing data regarding the item being manufactured and the sixth data structure for capturing data regarding inspection stations for the manufacturing process.

3. The system of claim 2, wherein the sixth data structure is linked to a seventh data structure for capturing data regarding an area of the manufacturing process.

4. The system of claim 2, wherein the data management system is operable to associate a defect in an item with an inspection station.

5. The system of claim 1 wherein the second data structure is linked to an eighth data structure for capturing data regarding potential defects for the components of the item and a ninth data structure for capturing data regarding the inspection stations and components inspected thereby.

6. The system of claim 5, wherein the ninth data structure is linked to a tenth data structure and an eleventh data structure, the tenth data structure for capturing data regarding inspection stations for the manufacturing process and the eleventh data structure for capturing data regarding components of the item.

7. The system of claim 5, wherein the ninth data structure specifies associations between inspection stations and the components of the item.

8. The system of claim 7, wherein a plurality of inspection stations are associated with one component.

9. The system of claim 5, wherein the second data structure specifies associations between potential defects and components of an item.

10. The system of claim 5, wherein the second data structure is linked to a twelfth data structure for capturing data regarding the location of a defect.

11. The system of claim 10, wherein the data management system is operable to associate a defect with a location on an item.

12. The system of claim 5, wherein the second data structure is linked to a thirteenth data structure for capturing standardized defect codes.

13. The system of claim 5, wherein the data management system is able to associate a defect with a component and an inspection station.

14. The system of claim 1, wherein the third data structure is adapted to capture data regarding departments of the manufacturing process associated with components of the item.

15. The system of claim 14, wherein the third data structure is linked to a fourteenth data structure and fifteenth structure, the fourteenth data structure for capturing data regarding a department in the manufacturing process and the fifteenth data structure for capturing data regarding sub-components of components.

16. The system of claim 15, wherein the data management system is operable to associate a defect with a department in the manufacturing process.

17. The system of claim 1, wherein the item comprises an automobile.

18. The system of claim 1, wherein the data organization comprises a relational database and the data structures comprise tables.

19. A method for quality control in a manufacturing process, the method comprising:
receiving inspection data regarding an item that is being manufactured, the item having a plurality of components;
inserting the data into a data organization comprising:
a first data structure for capturing identification data regarding the item being manufactured and the inspections for the item,
a second data structure for capturing data regarding defects in the components of the item,
a third data structure for capturing data regarding the components of the item, and
a fourth data structure linked to the first, second, and third data structures for capturing data regarding the item, the inspections for the item, the defects for the components of the item, and the components containing the defects; and
generating responses to queries by using the data organization.

20. The method of claim 19, wherein the first data structure is linked to a fifth data structure and a sixth data structure, the fifth data structure for capturing data regarding the item being manufactured and the sixth data structure for capturing data regarding inspection stations for the manufacturing process.

21. The method of claim 20, further comprising associating a defect in an item with an inspection station.

22. The method of claim 19, wherein the second data structure is linked to an seventh data structure for capturing data regarding potential defects for the components of the item and an eighth structure for capturing data regarding the inspection stations and components inspected thereby.

23. The method of claim 22, wherein the eighth data structure specifies associations between inspection stations and the components of the item.

24. The method of claim 22, wherein the second data structure specifies associations between potential defects and components of an item.

25. The method of claim 22, wherein the second data structure is linked to a ninth data structure for capturing data regarding the location of a defect.

26. The method of claim 22, further comprising associating a defect with a component and an inspection station.

27. The method of claim 19, wherein the third data structure is adapted to capture data regarding departments of the manufacturing process associated with components of the item.

28. The method of claim 27, further comprising associating a defect with a department in the manufacturing process.

29. A system for quality control in a manufacturing process, the method comprising:
means for receiving inspection data regarding an item that is being manufactured, the item having a plurality of components;
means for inserting the data into a data organization comprising:
a first data structure for capturing identification data regarding the item being manufactured and the inspections for the item,
a second data structure for capturing data regarding defects in the components of the item,
a third data structure for capturing data regarding the components of the item, and
a fourth data structure linked to the first, second, and third data structures for capturing data regarding the item, the inspections for the item, the defects for the components of the item, and the components containing the defects; and
means for generating responses to queries by using the data organization.

30. A quality control system for a manufacturing process, the system comprising:
a plurality of inspection stations for receiving data regarding an item that is being manufactured, the item having a plurality of components; and
a data management system coupled to the inspection stations, the data management system comprising:
a data manager operable to generate responses to queries by using a data organization comprising:
a first data structure for capturing identification data regarding the item being manufactured and the inspections for the item;
a second data structure linked to the first data structure, the second data structure for capturing data regarding the item being manufactured;
a third data structure linked to the first data structure, the third for capturing data regarding inspection stations for the manufacturing process;
a fourth data structure linked to the third data structure for capturing data regarding an area of the manufacturing process;
a fifth data structure for capturing data regarding defects in the components of the item, the fifth data structure specifying associations between potential defects and components of an item;
a sixth data structure linked to the fifth data structure for capturing data regarding potential defects for the components of the item;
a seventh data structure linked to the fifth data structure for capturing data regarding the location of a defect;
an eighth data structure linked to the fifth data structure for capturing data regarding the inspection stations and components inspected thereby, the eighth data structure specifying associations between inspection stations and the components of the item, wherein the third data structure is also linked to the eighth data structure;
a ninth data structure linked to the eighth data structure for capturing data regarding components of the item;
a tenth data structure for capturing data regarding the components of the item and departments of the manufacturing process associated with components of the item;
an eleventh data structure linked to the tenth data structure for capturing data regarding a department in the manufacturing process;
a twelfth data structure linked to the tenth data structure for capturing data regarding sub-components of components, wherein the ninth data structure is linked to the twelfth data structure; and
a thirteenth data structure linked to the first, fifth, and tenth data structures for capturing data regarding the item, the inspections for the item, the defects for the components of the item, and the components containing the defect;
the data management system, using the data organization, operable to:
associate a defect in an item with an inspection station;
associate a defect with a location on an item;
associate a defect with a component and an inspection station; and
associate a defect with a department in the manufacturing process.
